(19) United States
(12) Patent Application Publication
(10) Pub. No.: US 2025/0391869 A1
(43) Pub. Date: Dec. 25, 2025

(54) POSITIVE ELECTRODE FOR RECHARGEABLE LITHIUM BATTERY AND RECHARGEABLE LITHIUM BATTERY COMPRISING THE SAME

(71) Applicant: SAMSUNG SDI CO., LTD., Yongin-si (KR)

(72) Inventors: Seunghyun JEON, Yongin-si (KR); Beom Kwon KIM, Yongin-si (KR); Youngkwang CHO, Yongin-si (KR); Seung-Hun HAN, Yongin-si (KR); Moonju CHO, Yongin-si (KR); Hyunwoo KIM, Yongin-si (KR); Seonghyun LIM, Yongin-si (KR)

(73) Assignee: SAMSUNG SDI CO., LTD., Yongin-si (KR)

(21) Appl. No.: 19/233,333

(22) Filed: Jun. 10, 2025

(30) Foreign Application Priority Data
Jun. 21, 2024 (KR) 10-2024-0081388

(51) Int. Cl. H01M 4/62; H01M 4/36; H01M 4/58; H01M 10/0525

(52) U.S. Cl. CPC H01M 4/622; H01M 4/366; H01M 4/5825; H01M 10/0525

(57) ABSTRACT

Examples of the disclosure include a positive electrode for a rechargeable lithium battery, and a rechargeable lithium battery including the positive electrode. The positive electrode for the rechargeable lithium battery includes a positive electrode current collector, a positive electrode active material layer, and a positive electrode functional layer between the positive electrode current collector and the positive electrode active material layer. The positive electrode functional layer includes a lithium iron phosphate-based compound, polyvinyl alcohol, and polyacrylic acid.

### CROSS-REFERENCE TO RELATED APPLICATION

This application claims the benefit of priority to Korean Patent Application No. 10-2024-0081388 filed in the Korean Intellectual Property Office on Jun. 21, 2024, the entire contents of which are incorporated herein by reference.

### BACKGROUND

### 1. Field

A positive electrode for a rechargeable lithium battery, and a rechargeable lithium battery including the positive electrode are disclosed.

### 2. Description of the Related Art

Rechargeable lithium batteries, which are typically easy to carry as well as implement high energy density, are widely used as power sources for various devices such as, e.g., mobile information terminals such as smart phones, laptops, and the like. Rechargeable lithium batteries with high safety and high capacity as power sources for hybrid vehicles and electric vehicles or for storing electric power may be advantageous.

Because the rechargeable lithium batteries typically secure rapid charging characteristics as well as high capacity and high safety, a low-cost lithium iron phosphate-based compound may be a positive electrode active material. A lithium iron phosphate-based compound has a stable structure, and also desired or improved thermal stability, as a phosphoric acid-based material itself is used as a flame retardant material.

In a conventional positive electrode functional layer, inorganic particles with desired or improved thermal stability such as silica, zirconium, or the like have been used, but such inorganic particles are not configured to constitute a positive electrode active material. On the other hand, the lithium iron phosphate-based compound instead of the inorganic particles may be included in a positive electrode functional layer, which has advantages of securing desired or improved thermal stability, as well as being configured to constitute a positive electrode active material.

In order to increase or maximize the safety effect of the positive electrode functional layer including the lithium iron phosphate-based compound, the positive electrode functional layer should be relatively thick, but the thicker the positive electrode functional layer, the more negatively the thickness thereof affects energy density. In addition, when other additives in addition to the lithium iron phosphate-based compound are added to the positive electrode functional layer, flexibility and adhesive strength may be deteriorated, and because a content of the positive electrode active material is reduced by a content of the added additives, the energy density may be further deteriorated.

Accordingly, it may be advantageous to design a positive electrode with advantageous electrode plate characteristics as well as high safety and high energy density.

### SUMMARY

Some example embodiments include a positive electrode for a rechargeable lithium battery having advantageous plate characteristics while ensuring high safety and high energy density.

Some example embodiments include a rechargeable lithium battery including the positive electrode.

In some example embodiments, a positive electrode for a rechargeable lithium battery includes a positive electrode current collector, a positive electrode active material layer, and a positive electrode functional layer between the positive electrode current collector and the positive electrode active material layer. The positive electrode functional layer includes a lithium iron phosphate-based compound, polyvinyl alcohol, and polyacrylic acid.

In some example embodiments, a rechargeable lithium battery includes the aforementioned positive electrode, negative electrode, and electrolyte.

According to some example embodiments, a positive electrode for a rechargeable lithium battery may achieve high safety and high energy density while also having advantageous electrode plate characteristics (securing adhesive strength and viscosity).

### BRIEF DESCRIPTION OF THE DRAWINGS

FIGS. 1 to 4 are cross-sectional views schematically illustrating rechargeable lithium batteries according to some example embodiments.

FIG. 5 is a Nyquist plot illustrating the impedance for the rechargeable lithium battery cells of Example 1 and Comparative Example 1 discussed below.

### DETAILED DESCRIPTION

Hereinafter, example embodiments are described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It is understood that when an element such as a layer, film, region, or substrate is referred to as being on: another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

The average particle diameter may be measured by a method well known to those skilled in the art, for example, by a particle size analyzer, or by a transmission electron microscope image or a scanning electron microscope image. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D₅₀) of particles having a cumulative volume of 50 volume % in the particle size distribution. As used herein, when a definition is not otherwise provided, the average particle diameter means a diameter (D₅₀) of particles having a cumulative volume of 50 volume % in the particle size distribution that is obtained by measuring the size (diameter or major axis length) of about 20 particles at random in a scanning electron microscope image.

Herein, or: is not to be construed as an exclusive meaning, for example, A or B: is construed to include A, B, A+B, and the like.

“Metal” is interpreted as a concept including ordinary metals, transition metals and metalloids (semi-metals).

When the terms “about” or “substantially” are used in this specification in connection with a numerical value, it is intended that the associated numerical value include a tolerance of +10% around the stated numerical value. When ranges are specified, the range includes all values therebetween such as increments of 0.1%.

Hereinafter, a positive electrode and rechargeable lithium battery is sequentially described.

### Positive Electrode

A positive electrode for a rechargeable lithium battery according to some example embodiments includes a positive electrode current collector, a positive electrode active material layer, and a positive electrode functional layer between the positive electrode current collector and the positive electrode active material layer, wherein the positive electrode functional layer includes a lithium iron phosphate-based compound, polyvinyl alcohol, and polyacrylic acid.

### Positive Electrode Functional Layer

According to some example embodiments, the positive electrode functional layer includes a lithium iron phosphate-based compound.

The lithium iron phosphate-based compound may be represented by, for example, Chemical Formula 1 or 2.

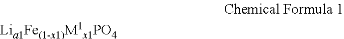

In Chemical Formula 1, 0.90≤a1≤1.5, 0≤x1≤0.4, and M¹ is or includes at least one of Al, B, Ca, Ce, Cr, Cu, La, Mg, Mn, Mo, Nb, Ni, Si, Sn, Sr, Ti, V, W, Y, Zn, Zr, or a combination thereof:

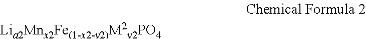

In Chemical Formula 2, 0.90≤a2≤1.5, 0.1≤x2≤0.9, 0≤y2≤0.9, and M² is or includes at least one of Al, B, Ca, Ce, Cr, Cu, La, Mg, Mo, Nb, Ni, Si, Sn, Sr, Ti, V, W, Y, Zn, Zr, or a combination thereof.

The lithium iron phosphate-based compound may be in the form of particles, and the average particle diameter (D₅₀) of the particles may be in a range of about 0.01 μm to about 2 μm, for example, about 0.1 μm to about 1 μm, or about 0.2 μm to about 0.9 μm. The lithium iron phosphate-based compound may be in the form of secondary particles formed by agglomeration of a plurality of primary particles, a single particle, or a combination thereof. The secondary particles may be agglomerates of primary particles having a size in a range of about 10 nm to about 400 nm, and an average particle diameter of the secondary particles may be in a range of about 2 μm to about 15 μm. The average particle diameter of the single particles may be in a range of about 10 nm to about 900 nm, or about 100 nm to about 300 nm. Herein, the average particle diameter means a size (D₅₀) of particles having a cumulative volume of 50 volume % in the particle size distribution that is obtained by measuring the size of about 20 particles at random from a scanning electron microscope image.

The lithium iron phosphate-based compound may further include a carbon coating layer on the particle surface. The carbon coating layer may improve the electrical conductivity of the lithium iron phosphate-based compound and reduce the resistance of the positive electrode. The carbon coating layer may be derived from at least one raw material such as or including, for example, at least one of glucose, sucrose, lactose, starch, oligosaccharide, polyoligosaccharide, fructose, cellulose, polymers of furfuryl alcohol, a block copolymer of ethylene and ethylene oxide, vinyl resins, a cellulose resin, a phenol resin, a pitch resin, and a tar resin. For example, the raw material may be placed on the surface of the lithium iron phosphate-based compound particles, and subsequently fired to form a carbon coating layer.

The positive electrode functional layer may substantially secure price competitiveness and heat resistance and high safety compared to other positive electrode active materials by including the lithium iron phosphate-based compound, and since the lithium iron phosphate-based compound has higher resistance than other materials applied to positive electrode active materials, the lithium iron phosphate-based compound can exhibit an insulating effect when included in the positive electrode functional layer.

The lithium iron phosphate-based compound can occupy most of the content in the positive electrode functional layer, as further explained below.

For example, the content of the lithium iron phosphate-based compound may be greater than or equal to about 94 wt % based on 100 wt % of the positive electrode functional layer. For example, the content of the lithium iron phosphate-based compound may be greater than or equal to about 94.5 wt % or greater than or equal to about 95 wt %, or the upper limit of the content of the lithium iron phosphate-based compound may be less than or equal to about 96 wt % or less than or equal to about 95.5 wt % based on 100 wt % of the positive electrode functional layer.

According to some example embodiments, the positive electrode functional layer can substantially secure appropriate adhesive strength and viscosity, even with a relatively small amount of polyvinyl alcohol and polyacrylic acid as binders, and thus can include a relatively large amount of lithium iron phosphate-based compound as described above compared to other positive electrode functional layers, and can be advantageous in securing high safety and high energy density.

The positive functional layer may include at least one of polyvinyl alcohol and polyacrylic acid as a binder.

Conventionally, the positive electrode functional layer includes an organic binder. Examples of the organic binder may include at least one of polyvinyl fluoride, polyvinyl pyrrolidone, polyurethane, polytetrafluoroethylene, polyvinylidene fluoride, polyethylene, polypropylene, and the like. In the case of known positive electrode functional layers using such an organic binder, the thickness of the positive electrode functional layer may be designed to be relatively thick in order to achieve a safety advantage. However, as a result, the content of lithium iron phosphate-based compound is relatively reduced, making it challenging to achieve adhesive strength and viscosity, and making it challenging to implement high energy density. Accordingly, in examples of the current disclosure, an aqueous binder is included instead of an organic binder. When polyvinyl alcohol and polyacrylic acid are included together among water-based binders, it is possible to achieve appropriate adhesive strength and viscosity that is easy to coat as a positive electrode functional layer, and it is advantageous in ensuring safety. For example, when polyvinyl alcohol is included alone as a binder, the adhesive strength is reduced, and it is difficult to exhibit the slurry viscosity characteristics. Therefore, in order to secure a desired or appropriate adhesive strength and viscosity, the binder content may be increased. As a result, the content of the positive electrode active material is relatively reduced, making it challenging to achieve a high energy density. When polyacrylic acid is included alone as a binder, the strong electrostatic properties of polyacrylic acid cause the active materials to become entangled, which may result in shear thickening, making coating difficult. However, when polyacrylic acid and polyvinyl alcohol are included together, the high insulating strength of polyvinyl alcohol can reduce or suppress the electrostatic properties of polyacrylic acid, thereby reducing or suppressing shear thickening, and thus obtaining a viscosity that is easy to coat, and is advantageous in ensuring safety. When comparing a positive electrode functional layer using polyvinyl alcohol and polyacrylic acid together with a positive electrode functional layer using a conventional organic binder, in order for the positive electrode functional layer using the conventional organic binder to exhibit the same performance (electrode plate characteristics such as appropriate adhesive strength and viscosity) as the positive electrode functional layer according to some example embodiments, a larger content of the organic binder may have to be included, which relatively reduces the content of the lithium iron phosphate-based compound, and is disadvantageous for securing high safety and high energy density.

According to some example embodiments, the positive electrode functional layer has sufficient safety effects even with a relatively small amount compared to a functional layer including a conventional organic binder, is advantageous in securing energy density, and includes polyvinyl alcohol and polyacrylic acid as aqueous binders, thereby securing appropriate adhesive strength and viscosity compared to when having polyvinyl alcohol or polyacrylic acid alone, and thus has an advantage of easy coating.

The contents of polyvinyl alcohol and polyacrylic acid included in the positive electrode functional layer can be appropriately adjusted to secure appropriate adhesive strength and viscosity.

A ratio (A/B) of the content of polyvinyl alcohol (A) and the content of polyacrylic acid (B) in the positive electrode functional layer may be in a range of about 0.5 to about 1.3. For example, the ratio of the above contents (A/B) may be greater than or equal to about 0.52, greater than or equal to about 0.54, greater than or equal to about 0.56, greater than or equal to about 0.58, greater than or equal to about 0.6, greater than or equal to about 0.62, greater than or equal to about 0.64, or greater than or equal to about 0.66, or less than or equal to about 1.25, less than or equal to about 1.2, less than or equal to about 1.15, less than or equal to about 1, less than or equal to about 0.9, less than or equal to about 0.8, or less than or equal to about 0.7. By controlling the ratio (A/B) of the content of polyvinyl alcohol (A) and the content of polyacrylic acid (B) in the positive electrode functional layer within any of the above-mentioned ranges, shear thickening is reduced or suppressed, thereby ensuring slurry stability and dispersibility, making coating easier and ensuring appropriate electrode plate adhesive strength. By ensuring that the ratio of the content of polyvinyl alcohol and the content of polyacrylic acid in the above-mentioned positive electrode functional layer is within any of the above-mentioned ranges, it is possible to secure appropriate adhesive strength and viscosity, thereby facilitating coating.

The positive electrode functional layer includes the polyvinyl alcohol and polyacrylic acid as binders, thereby ensuring appropriate adhesive strength and viscosity even with a smaller amount compared to other binders, and accordingly, the content of the lithium iron phosphate-based compound included in the positive electrode functional layer may be advantageously achieve high safety and high energy density.

In various examples, the positive electrode functional layer may not further include a binder other than the polyvinyl alcohol and polyacrylic acid, and may not further include a conductive material. That is, the positive electrode functional layer may implement desired or improved electrode plate characteristics even without including any binder other than polyvinyl alcohol and polyacrylic acid, may not include a conductive material, may implement desired or improved lithium ionic conductivity and electrical conductivity even without adding any other additives, and can secure high safety and high energy density by combining the aforementioned binders. In examples, binders other than polyvinyl alcohol and polyacrylic acid indicated compounds that are commonly known as binders.

For example, the content of a binder other than polyvinyl alcohol and polyacrylic acid in the positive electrode functional layer may be less than about 1 wt %, and for example, less than or equal to about 0.9 wt %, less than or equal to about 0.8 wt %, less than or equal to about 0.7 wt %, less than or equal to about 0.6 wt %, less than or equal to about 0.5 wt %, less than or equal to about 0.4 wt %, less than or equal to about 0.3 wt %, less than or equal to about 0.2 wt %, less than or equal to about 0.1 wt %, or 0 wt % based on 100 wt % of the positive electrode functional layer.

In addition, the content of the conductive material in the positive electrode functional layer may be less than about 1 wt %, and for example, less than or equal to about 0.9 wt %, less than or equal to about 0.8 wt %, less than or equal to about 0.7 wt %, less than or equal to about 0.6 wt %, less than or equal to about 0.5 wt %, less than or equal to about 0.4 wt %, less than or equal to about 0.3 wt %, less than or equal to about 0.2 wt %, less than or equal to about 0.1 wt %, or about 0 wt % based on 100 wt % of the positive electrode functional layer.

According to some example embodiments, the positive electrode functional layer may have a content of a binder other than polyvinyl alcohol and polyacrylic acid of 0% in the positive electrode functional layer, and a content of a conductive material of 0%. That is, the positive electrode functional layer may include only the aforementioned lithium iron phosphate-based compound, polyvinyl alcohol, and polyacrylic acid.

The positive electrode functional layer may have a thickness in a range of about 1 μm to about 3.5 μm. For example, the positive electrode functional layer may have a thickness of about 1.5 μm to about 3.5 μm, for example, about 1 μm to about 3 μm, about 1 μm to about 2.5 μm, or about 1 μm to about 2 μm. The positive electrode functional layer may achieve appropriate adhesive strength and viscosity even with a low thickness, or with a thin positive electrode functional layer, compared to conventional positive electrode functional layers using other binders, by using polyvinyl alcohol and polyacrylic acid together as a binder, and may be advantageous in securing high safety and high energy density.

The positive electrode functional layer is located between the positive electrode current collector and the positive electrode active material layer described below. The positive electrode functional layer may be located only between the positive electrode current collector and the positive electrode active material layer, or may be located between the positive electrode current collector and the positive electrode active material layer, but also on another surface of the positive electrode active material layer where the positive electrode functional layer is not located.

When the positive electrode functional layer is located on both surfaces of the positive electrode active material layer, the total thickness of the positive electrode functional layer may be in a range of about 2 μm to about 7 μm. For example, the total thickness may be in a range of about 2 μm to about 5 μm, about 2 μm to about 4 μm, or about 3 μm to about 5 μm.

The positive electrode functional layer may achieve improved adhesive strength compared to a positive electrode functional layer that has a conventional organic binder. The adhesive strength may be measured in the same manner as described in the “Evaluation of adhesive strength, viscosity and T.I. of positive electrode functional layer” section of Evaluation Example 1 below.

For example, the adhesive strength of the positive electrode functional layer may be greater than or equal to about 25 gf/mm, greater than or equal to about 26 gf/mm, greater than or equal to about 27 gf/mm, greater than or equal to about 28 gf/mm, greater than or equal to about 29 gf/mm, greater than or equal to about 30 gf/mm, or greater than or equal to about 31 gf/mm. The positive electrode functional layer can exhibit desired or improved adhesive strength even when added in a lower amount than the amount of the existing organic binder by using a binder of a combination of polyvinyl alcohol and polyacrylic acid instead of the existing organic binder.

### Positive Electrode Active Material Layer

The positive electrode active material layer may include a positive electrode active material.

The positive electrode active material may include a compound (lithiated intercalation compound) capable of intercalating and deintercallating lithium. For example, at least one composite oxide of lithium and a metal such as or including at least one of cobalt, manganese, nickel, and combinations thereof may be used.

The composite oxide may be or include a lithium transition metal composite oxide, and examples thereof may include at least one of a lithium nickel-based oxide, a lithium cobalt-based oxide, a lithium manganese-based oxide, a lithium iron phosphate-based compound, a cobalt-free lithium nickel-manganese-based oxide, a lithium-manganese-rich composite oxide, or a combination thereof.

As an example, a compound represented by any of the following chemical formulas may be used. LiₐA_{1-b}XbO_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O₂₋ₐDₐ (0.90≤a≤1.8, 0<b>0.5, 0<c<0.5, 0<<<2); LiₐNi_{1-b-c}Mn_{b}X_{c}O₂₋ₐDₐ (0.90≤a≤1.8, 0≤b≤0.5, 0≤c≤0.5, 0<<<2); LiₐNi_{b}Co_{c}LlₐGeO₂ (0.90≤a≤1.8, 0≤b≤0.9, 0≤c≤0.5, 0≤d≤0.5, 0≤e≤0.1); LiaNiGbO₂ (0.90≤a≤1.8, 0.001≤b≤0.1); LiaCoGbO₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{b}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al or a combination thereof.

The positive electrode active material may be or include the aforementioned lithium transition metal composite oxide, and for example, may be the same as or different from the lithium iron phosphate-based compound included in the positive electrode functional layer. The positive electrode active material according to some example embodiments may be or include, but is not limited to, a lithium cobalt-based oxide.

A content of the positive electrode active material may be in a range of about 60 wt % to about 99.9 wt %, about 70 wt % to about 99.8 wt %, about 80 wt % to about 99 wt %, or about 90 wt % to about 99.8 wt %, or about 94 wt % to about 99 wt %, based on 100 wt % of the positive electrode active material layer.

The positive electrode active material layer may optionally further include a binder and/or a conductive material.

The binder is configured to improve binding properties of positive electrode active material particles with one another and with a current collector. Examples of binders may include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but are not limited thereto.

The conductive material is included to provide electrode conductivity, and any electrically conductive material may be included as a conductive material unless the electrically conductive material causes a chemical change in or to the battery. Examples of the conductive material may include a carbon-based material such as at least one of natural graphite, artificial graphite, carbon black, acetylene black, ketjen black, a carbon fiber, a carbon nanofiber, a carbon nanotube, and the like; a metal-based material of a metal powder or a metal fiber including at least one of copper, nickel, aluminum, silver, and the like; a conductive polymer such as a polyphenylene derivative; or a mixture thereof.

In the positive electrode active material layer, a content of the binder may be in a range of about 0.1 wt % to about 5 wt %, or about 0.5 wt % to about 3 wt %, based on a total weight of the positive electrode active material layer, and a content of the conductive material may be in a range of about 0.1 wt % to about 5 wt %, or about 0.1 wt % to about 3 wt %, based on a total weight of the positive electrode active material layer.

A thickness of the positive electrode active material layer may be in a range of about 20 μm to about 200 μm, and for example, the thickness of the positive electrode active material layer may be about 25 μm to about 150 μm, about 25 μm to about 100 μm, or about 25 μm to about 80 μm, but is not limited thereto. The thickness of the positive electrode active material layer can be measured through SEM images of the cross-section of the compressed positive electrode. The thickness of the positive electrode active material layer refers to the total thickness of the positive electrode active material layer. When the positive electrode active material layer is located on only one surface of the positive electrode current collector, the total thickness refers to the thickness of the cross section. When the positive electrode active material layer is located on both surfaces of the positive electrode current collector, the total thickness refers to the thickness of both surfaces.

### Positive Electrode Current Collector

The positive electrode current collector is not particularly limited as long as the positive electrode current collector has conductivity and does not cause a chemical change in the rechargeable lithium battery, and may be or include an aluminum foil having a thickness in a range of about 10 μm to about 15 μm.

### Others

The positive electrode may be manufactured according to conventional positive electrode manufacturing methods. For example, the positive electrode may be formed by mixing at least two of a lithium iron phosphate-based compound, polyvinyl alcohol, and polyacrylic acid to prepare a composition for forming a positive electrode functional layer, coating the composition on the positive electrode current collector, and drying, thereby forming a positive electrode functional layer, or the positive electrode active material layer may be formed by mixing a positive electrode active material, and optionally a binder and/or a conductive material, into a solvent to prepare a positive electrode active material slurry, coating the positive electrode active material slurry on the positive electrode functional layer, and then drying and compressing.

The solvent may be or include a solvent commonly used in the technical field, such as dimethyl sulfoxide (DMSO), isopropyl alcohol, N-methylpyrrolidone (NMP), acetone, or water, etc., and one type of the above solvents may be used alone or the solvent may include a mixture of two or more types. The amount of the solvent is sufficient to dissolve or disperse the positive electrode active material, the conductive material, and the binder in consideration of the coating thickness and manufacturing yield of the slurry, and to have a viscosity that can exhibit a substantial thickness uniformity when coated for subsequent manufacturing of the positive electrode.

### Rechargeable Lithium Battery

A rechargeable lithium battery according to some example embodiments includes the aforementioned positive electrode, a negative electrode, and an electrolyte.

Since the contents of the positive electrode are the same as the contents described above, the contents thereof are omitted, and the negative electrode and electrolyte are described below.

### Negative Electrode

According to some example embodiments, the negative electrode includes a carbon-based negative electrode active material.

The negative electrode may include a negative electrode current collector, and a negative electrode active material layer on the negative electrode current collector and including a carbon-based negative electrode active material.

The carbon-based negative electrode active material may include crystalline carbon, amorphous carbon, or a combination thereof. The crystalline carbon may be irregular, or sheet, flake, spherical, or fiber shaped natural graphite or artificial graphite. The amorphous carbon may be or include at least one of a soft carbon, a hard carbon, a mesophase pitch carbonization product, calcined coke, and the like. The soft carbon refers to a carbon material that can be graphitized, and is a material that is easily graphitized by heat treatment at a high temperature, for example, about 2800° C. The hard carbon is a carbon material that cannot be graphitized or is finely graphitized by heat treatment.

The negative electrode active material layer may further include other types of negative electrode active materials in addition to the carbon-based negative electrode active material, and may further include, for example, at least one of a lithium metal, an alloy of lithium metal, a material capable of doping and dedoping lithium, etc.

As the lithium metal alloy, an alloy of lithium and a metal such as or including at least one of Na, K, Rb, Cs, Fr, Be, Mg, Ca, Sr, Si, Sb, Pb, In, Zn, Ba, Ra, Ge, Al, and Sn may be used.

The material capable of doping/dedoping lithium may be or include at least one of a Si-based negative electrode active material or a Sn-based negative electrode active material. The Si-based negative electrode active material may include silicon, a silicon-carbon composite, SiOₓ (0<x≤2), a Si-Q alloy (wherein Q is an element such as or including at least one of an alkali metal, an alkaline-earth metal, a Group 13 element, a Group 14 element (excluding Si), a Group 15 element, a Group 16 element, a transition metal, a rare earth element, and a combination thereof), or a combination thereof. The Sn-based negative electrode active material may be or include at least one of Sn, SnO₂, a Sn-based alloy, or a combination thereof.

The silicon-carbon composite may be a composite of silicon and amorphous carbon. According to some example embodiments, the silicon-carbon composite may be in the form of silicon particles with amorphous carbon coated on the surface of the silicon particles. For example, the silicon-carbon composite may include a secondary particle (core) in which silicon primary particles are assembled, and an amorphous carbon coating layer (shell) on the surface of the secondary particle. The amorphous carbon may also be present between the silicon primary particles, for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer on the surface of the core.

The Si-based negative electrode active material or Sn-based negative electrode active material may be mixed with the carbon-based negative electrode active material.

The negative electrode current collector is not particularly limited as long as the negative electrode current collector has conductivity and does not cause a chemical change in or to the rechargeable lithium battery, and may be or include a copper foil having a thickness in a range of about 10 μm to about 15 μm.

The above negative electrode active material layer may optionally further include a binder and/or a conductive material. The binder is configured to adhere the negative electrode active material particles to each other, and to adhere the negative electrode active material to the current collector. The binder may be or include a non-aqueous binder, an aqueous binder, a dry binder, or a combination thereof.

The non-aqueous binder may include at least one of polyvinylchloride, carboxylated polyvinylchloride, polyvinylfluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include at least one of a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof. When an aqueous binder is included as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and used. The alkali metal may be or include at least one of Na, K, or Li.

The dry binder may be or include a polymer material capable of becoming fiber, and may be or include, for example, at least one of polytetrafluoroethylene, polyvinylidene fluoride, a polyvinylidene fluoride-hexafluoropropylene copolymer, polyethylene oxide, or a combination thereof.

The conductive material is included to provide electrode conductivity and any electrically conductive material may be included as a conductive material unless the electrically conductive material causes a chemical change in or to the battery. Examples of the conductive material include a carbon-based material such as or including at least one of natural graphite, artificial graphite, carbon black, acetylene black, ketjen black, a carbon fiber, a carbon nanofiber, a carbon nanotube, and the like; a metal-based material of a metal powder or a metal fiber including at least one of copper, nickel, aluminum silver, and the like; a conductive polymer such as a polyphenylene derivative; or a mixture thereof.

The negative electrode active material may be included in an amount in a range of about 90 wt % to about 99.8 wt %, or about 94 wt % to about 99 wt %, based on 100 wt % of the negative electrode active material layer, and each of, or at least one of, the binder and the conductive material may be included in an amount in a range of about 0.1 wt % to about 5 wt %, or about 0.5 wt % to about 3 wt %, based on 100 wt % of the negative electrode active material layer.

The negative electrode may be manufactured according to a known method, and for example, the negative electrode may be manufactured by mixing a negative electrode active material, and optionally a binder and/or a conductive material, in a solvent on a negative electrode current collector to manufacture a negative electrode active material slurry, coating the negative electrode active material slurry on a positive electrode current collector, and then drying and compressing.

The solvent may be the same type as the solvent included in the positive electrode active material slurry, or may be an aqueous solvent.

### Electrolyte

For example, the electrolyte for a rechargeable lithium battery may be an electrolyte solution, which may include a non-aqueous organic solvent and a lithium salt.

The non-aqueous organic solvent may constitute a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include at least one of ethanol, isopropyl alcohol, and the like and the aprotic solvent may include at least one of nitriles such as R-CN (wherein R is a C2 to C20 linear, branched, or cyclic hydrocarbon group, a double bond, an aromatic ring, or an ether group, and the like; amides such as dimethylformamide; dioxolanes such as 1,3-dioxolane, 1,4-dioxolane, and the like; sulfolanes, and the like.

The non-aqueous organic solvent can be used alone or in a mixture of two or more types of solvents.

When using a carbonate-based solvent, a cyclic carbonate and a chain carbonate may be mixed, and the cyclic carbonate and the chain carbonate may be mixed in a volume ratio in a range of about 1:1 to about 1:9.

The lithium salt dissolved in the organic solvent is configured to supply lithium ions in a battery, to enable a basic operation of a rechargeable lithium battery, and to improve transportation of the lithium ions between positive and negative electrodes. Examples of the lithium salt may include at least one of LiPF₆, LiBF₄, LiSbF₆, LiAsF₆, LiClO₄, LiAlO₂, LiAlCl₄, LIPO₂F₂, LICl, LiI, LiN(SO₃C₂F₅)₂, Li(FSO₂)₂N (lithium bis(fluorosulfonyl)imide; LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethane sulfonate, lithium difluorobis(oxalato)phosphate (LiDFOB), and lithium bis(oxalato) borate (LiBOB).

### Separator

Depending on the type of the rechargeable lithium battery, a separator may be present between the positive electrode and the negative electrode. The separator may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be or include a polymer film formed of or including any one polymer such as or including at least one of polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic-based polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

### Rechargeable Lithium Battery

A rechargeable lithium battery according to some example embodiments includes the aforementioned positive electrode, negative electrode, and electrolyte.

The rechargeable lithium battery may include a positive electrode, a negative electrode, a separator between the positive electrode and the negative electrode, and an electrolyte.

Some example embodiments include an all-solid-state rechargeable battery including the positive electrode, the negative electrode, and a solid electrolyte layer between the positive electrode and the negative electrode.

Hereinafter, for convenience, the configuration of a lithium-ion battery using a liquid electrolyte is described in detail.

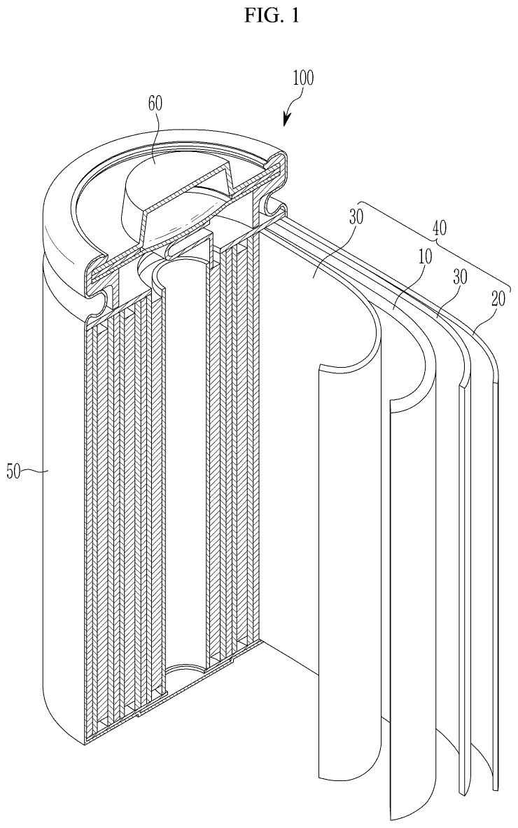

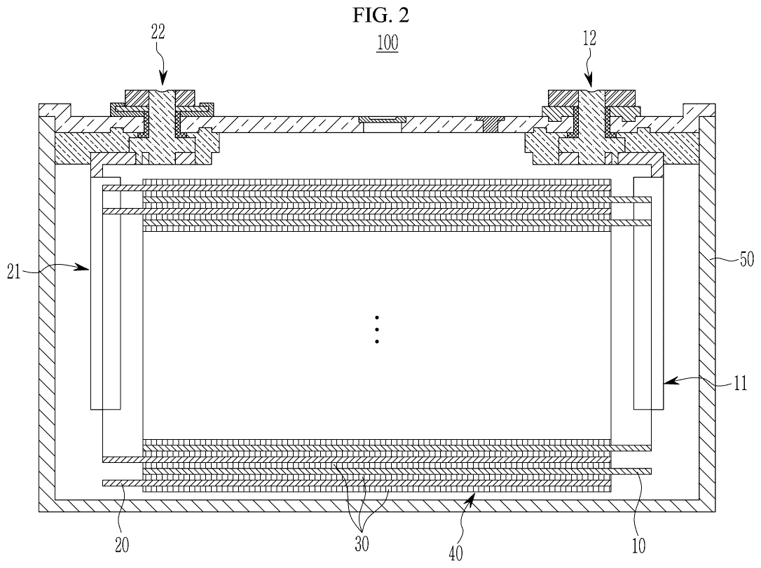

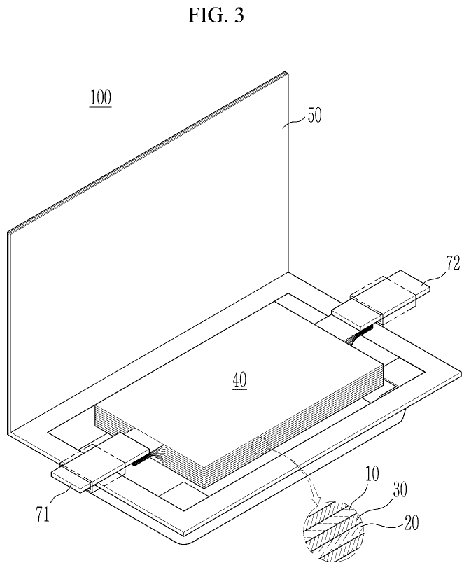

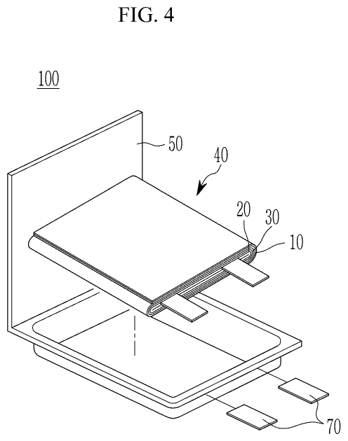

The rechargeable lithium battery may be classified into cylindrical, prismatic, pouch, coin, etc. depending on the shape. FIGS. 1 to 4 are schematic diagrams illustrating the rechargeable lithium battery according to some example embodiments, where FIG. 1 is a cylindrical battery, FIG. 2 is a prismatic battery, and FIGS. 3 and 4 are a pouch-shaped battery. Referring to FIGS. 1 to 4, the rechargeable lithium battery 100 includes an electrode assembly 40 with a separator 30 interposed between the positive electrode 10 and the negative electrode 20, and a case 50 in which the electrode assembly 40 is housed. The positive electrode 10, the negative electrode 20, and the separator 30 may be impregnated with an electrolyte (not shown). The rechargeable lithium battery 100 may include a sealing member 60 that seals the case 50 as shown in FIG. 1. Additionally, in FIG. 2, the rechargeable lithium battery 100 may include a positive electrode lead tab 11, a positive electrode terminal 12, a negative lead tab 21, and a negative electrode terminal 22. As shown in FIGS. 3 and 4, the rechargeable lithium battery 100 includes an electrode tab 70 illustrated in FIG. 4, or a positive electrode tab 71 and a negative electrode tab 72 illustrated in FIG. 3, the electrode tabs 70/71/72 forming an electrical path for inducing the current formed in the electrode assembly 40 to the outside of the battery 100.

Examples and comparative examples of the present disclosure are described below. However, the following examples are only examples of the present disclosure, and the present disclosure is not limited to the following examples.

### EXAMPLES AND COMPARATIVE EXAMPLES

A positive electrode functional layer, a positive electrode, and a rechargeable lithium battery cell were manufactured using the following method.

### Example 1

### (1) Manufacturing of Positive Electrode

A composition for a positive electrode functional layer was prepared by mixing polyvinyl alcohol and polyacrylic acid as a binder, dispersing the mixture in distilled water, and adding LiFePO₄ having an average particle diameter of 1.5 μm as a lithium iron phosphate-based compound thereto. Herein, the lithium iron phosphate-based compound, the polyvinyl alcohol, and the polyacrylic acid had a weight ratio of 95:2:3.

The composition for a positive electrode functional layer was coated on both surfaces of a 10 μm-thick Al foil at a loading level of 1.5 mg/cm², and then dried to form a positive electrode functional layer on the positive electrode current collector.

On the other hand, LiCoO₂ as a positive electrode active material, polyvinylidene as a fluoride binder, and carbon nanotube as a conductive material were mixed in a weight ratio of 98.7:0.9:0.4 (positive electrode active material: binder: conductive material) to prepare a positive electrode active material composition. The positive electrode active material composition was dispersed in an N-methyl pyrrolidone solvent to prepare a positive electrode active material slurry, and the positive electrode active material slurry was coated on the positive electrode functional layer, and then dried and compressed to manufacture a positive electrode.

Herein, the positive electrode functional layer had a double-sided thickness of about 4 μm, and the positive electrode active material layer had a double-sided thickness of about 70 μm.

### (2) Manufacturing of Negative Electrode

97.5 wt % of graphite as a negative electrode active material, 1.5 wt % of carboxymethyl cellulose as a binder, and 1 wt % of a styrene butadiene rubber were dispersed in distilled water to prepare a negative electrode active material slurry. The negative electrode active material slurry was coated on a 10 μm-thick Cu foil and then, dried and compressed to manufacture a negative electrode.

### (3) Manufacturing of Rechargeable Lithium Battery Cell

Subsequently, a 10 μm-thick polyethylene separator was interposed between the positive electrode and the negative electrode to manufacture an electrode assembly, and then, the electrode assembly was inserted, and an electrolyte was injected thereinto, manufacturing a rechargeable lithium battery cell (100 mAh level pouch cell). The electrolyte was prepared by mixing EC (ethylenecarbonate): EMC (ethylmethylcarbonate): DMC (dimethylcarbonate) in a volume ratio of 2:4:4 and dissolving 1.15 M LiPF₆ in the mixed solvent.

### Comparative Example 1

A positive electrode, a negative electrode, and a rechargeable lithium battery cell were manufactured substantially in the same manner as in Example 1, with a difference that the positive electrode functional layer was formed by using polyvinylidene fluoride, an organic binder, as the binder. Herein, in the positive electrode functional layer, the lithium iron phosphate-based compound and the polyvinylidene fluoride had a weight ratio of 90:10, and the positive electrode functional layer had a double-sided thickness of about 13 μm, and the positive electrode active material layer had a double-sided thickness of about 70 μm.

### Comparative Example 2

A positive electrode, a negative electrode, and a rechargeable lithium battery cell were manufactured substantially in the same manner as in Example 1, with a difference that the positive electrode functional layer was formed by mixing polyvinyl alcohol and polyacrylic acid in a weight ratio of 4:1.

Herein, the positive electrode functional layer had a double-sided thickness of about 4 μm, and the positive electrode active material layer had a double-sided thickness of about 70 μm.

### Comparative Example 3

A positive electrode, a negative electrode, and a rechargeable lithium battery cell were manufactured substantially in the same manner as in Example 1, with a difference that the positive electrode functional layer was formed by mixing polyvinyl alcohol and polyacrylic acid in a weight ratio of 3:2.

Herein, the positive electrode functional layer had a double-sided thickness of about 4 μm, and the positive electrode active material layer had a double-sided thickness of about 70 μm.

### Comparative Example 4

A positive electrode, a negative electrode, and a rechargeable lithium battery cell were manufactured substantially in the same manner as in Example 1, with a difference that the positive electrode functional layer was formed by using polyvinyl alcohol alone as a binder. Herein, in the positive electrode functional layer, the lithium iron phosphate-based compound and the polyvinyl alcohol had a weight ratio of 95:5, and the positive electrode functional layer had a double-sided thickness of about 4 μm, and the positive electrode active material layer had a double-sided thickness of about 70 μm.

### Comparative Example 5

A positive electrode, a negative electrode, and a rechargeable lithium battery cell were manufactured substantially in the same manner as in Example 1, with a difference that the positive electrode functional layer was formed by using polyvinyl alcohol alone as a binder. Herein, in the positive electrode functional layer, the lithium iron phosphate-based compound and the polyvinyl alcohol had a weight ratio of 95:5, and the positive electrode functional layer had a double-sided thickness of about 4 μm, and the positive electrode active material layer had a double-sided thickness of about 70 μm.

Evaluation Example 1. Evaluation of Adhesion, Viscosity, and Thixotropic Index (T.I) of Positive Electrode Functional Layer

The positive electrode functional layers formed in Example 1 and Comparative Examples 1 to 5 were measured with respect to adhesive strength. The adhesive strength between the positive electrode functional layer and the positive electrode current collector was evaluated, and the results are shown in Table 1 below.

An adhesive strength test was conducted by adhering a positive electrode functional layer formed on an Al foil to a polyvinylchloride (PVC) double-sided adhesive tape, peeling off the positive electrode functional layer to an angle of 180° (peel) at 25 mm/min to measure the adhesive strength by using a universal testing machine, and the results are shown in Table 1 below.

In addition, the compositions for a positive electrode functional layer, which was used to form the positive electrode functional layers of Example 1 and Comparative Examples 1 to 5, were respectively measured with respect to viscosity at room temperature (25° C.) at a shear rate of 0.01 s⁻¹ to 1000 s⁻¹, and the results are shown in Table 1 below.

In addition, a thixotropy index (TI) was calculated by inserting the viscosity at the shear rate of 1 s⁻¹ and 10 s⁻¹ in the viscosity measurement into Equation 1, and the results are shown in Table 1.

$$TI ( Thixotropy Index ) = log ( A / B ) \qquad Equation 1$$

In Equation 1, A is the viscosity when the shear rate is 1 s⁻¹, and B is the viscosity when the shear rate is 10 s⁻¹.

TABLE 1

| | Adhesive strength | Viscosity | |
|---|---|---|---|
| | (gf/mm) | (cps) | TI |
| Example 1 | 31.69 | 288 | 0.08 |
| Comparative Example 1 | 22.67 | 320 | 0.1 |
| Comparative Example 2 | 10.15 | 159 | 0.06 |
| Comparative Example 3 | 21.29 | 194 | 0.16 |
| Comparative Example 4 | 6.79 | 124 | 0.06 |
| Comparative Example 5 | 40.27 | 627 | 0.61 |

Referring to Table 1, compared with the positive electrode functional layer of Comparative Example 1, which used a conventional organic binder, the positive electrode functional layer of Example 1, which used a mixed binder of polyvinyl alcohol and polyacrylic acid, used the binder in a smaller amount than the amount of the organic binder of Comparative Example 1 but exhibited desired or improved adhesive strength and viscosity capable of easily securing coating properties.

On the other hand, the positive electrode functional layers of Example 1 and Comparative Examples 2 and 3, which used polyvinyl alcohol and polyacrylic acid as a binder, but Comparative Examples 2 and 3, which included a larger content of polyvinyl alcohol in the binder, were confirmed to have lower adhesive strength and viscosity than Example 1. If the adhesive strength was low, as in Comparative Examples 2 and 3, when the positive electrode functional layers of Comparative Examples 2 and 3 were placed into an electrolyte solution later, there were problems of easy detachment of electrode plates and if viscosity was low, non-uniform coating.

Comparative Examples 4 and 5, as described above, included polyvinyl alcohol or polyacrylic acid alone, wherein the positive electrode functional layer of Comparative Example 4, which included polyvinyl alcohol alone, was confirmed to exhibit significantly low adhesive strength and viscosity, and the positive electrode functional layer of Comparative Example 5, which included polyacrylic acid alone, exhibited excessively high adhesive strength and viscosity.

Accordingly, when the compositions for a positive electrode functional layer were measured with respect to adhesive strength, viscosity, and a thixotropy index, if the adhesive strength was at least greater than or equal to 20 gf/mm, the viscosity was within a range of 250 cps to 350 cps, and the thixotropy index was less than or equal to 0.1, it was possible to manufacture an electrode plate by easily securing slurry stability and coating. Referring to Table 1, because Example 1 and Comparative Example 1 satisfied these ranges of adhesive strength, viscosity, and thixotropy index, in the following rechargeable lithium battery evaluations, Example 1 and Comparative Example 1 alone were evaluated.

### Evaluation Example 2. Battery Performance Evaluation

The rechargeable lithium battery cells of Example 1 and Comparative Example 1 were charged to an upper limit voltage of 4.5 V at a constant current of 0.2 C and discharged to a discharge cut-off voltage of 2.75 V at 0.2 C at 23° C., and then, 0.2 C charge capacity, 0.2 C discharge capacity, and a ratio of the latter to the former as initial charge/discharge efficiency are shown in Table 2. In addition, the initial discharge capacity (mAh) was divided by a weight of an active material to obtain capacity per unit weight, and the results are shown in Table 2 below.

TABLE 2

| | 0.2 C | 0.2 C | Initial | Capacity per |
|---|---|---|---|---|
| | charge | discharge | efficiency | unit weight |
| | (mAh) | (mAh) | (%) | (mAh/g) |
| Example 1 | 4821 | 4806 | 99.7 | 179.0 |
| Comparative Example 1 | 4756 | 4734 | 99.6 | 177.3 |

Referring to Table 2, the rechargeable lithium battery cell of Example 1, compared with the cell of Comparative Example 1, was confirmed to exhibit improved charge/discharge efficiency and capacity per unit weight. In other words, the positive electrode functional layer of Example 1 including 5 wt % of polyvinyl alcohol and polyvinylacrylic acid was confirmed to exhibit increased energy density by increasing the lithium iron phosphate-based compound as much as decreasing the binder, compared with that of Comparative Example 1 including 10 wt % of polyvinylidene fluoride.

### Evaluation Example 3. Penetration Safety Evaluation

The rechargeable lithium battery cells of Example 1 and Comparative Example 1 were charged to an upper limit voltage of 4.5 V at a constant current of 0.5 C, cut off at a current rate of 0.05 C, while maintaining the constant voltage, and paused for 24 hours and then, completely penetrated a center thereof by a pin having a diameter of 3 mm at each speed of 100 mm/sec and 150 mm/sec to evaluate penetration stability according to the following criteria, and the results are shown in Table 3 below.

TABLE 3

| | Penetration speed (mm/s) | | | | | | | | | |
|---|---|---|---|---|---|---|---|---|---|---|
| | 100 mm/sec | | | | | 150 mm/sec | | | | |
| | 1st | 2nd | 3rd | 4th | 5th | 1st | 2nd | 3rd | 4th | 5th |
| Example 1 | ◯ | ◯ | ◯ | ◯ | ◯ | ◯ | ◯ | ◯ | ◯ | ◯ |
| Comparative | ◯ | X | ◯ | ◯ | ◯ | ◯ | ◯ | ◯ | ◯ | ◯ |
| Example 1 | | | | | | | | | | |

Evaluation criteria:
X: Thermal runaway phenomenon observed at exposure temperature during penetration
O: No thermal runaway phenomenon occurs at the exposure temperature during penetration.

Referring to Table 3, the rechargeable lithium battery cell of Example 1 exhibited no thermal runaway at the penetration speeds of 100 mm/sec and 150 mm/sec and thus desired or improved battery stability.

### Evaluation Example 4. Interface Resistance Evaluation

The rechargeable lithium battery cells of Example 1 and Comparative Example 1 were measured with respect to impedance by using an impedance analyzer (Solartron 1260A Impedance/Gain-Phase Analyzer) at an amplitude of +10 mV and a frequency of 10 mHz to 1 MHZ, which was shown as a Nyquist plot. The rechargeable lithium battery cells of Example 1 and Comparative Example 1 were charged at 0.2 C-rate under the condition of 4.5 V CCCV/CC in a state of SOC (site of charge) 100 and cut off at 0.02 C rate at 23° C. and then, stabilized for 1 hour and then, measured in a full charge state. Interface resistance of the cells was determined by a position and a size of a semicircle.

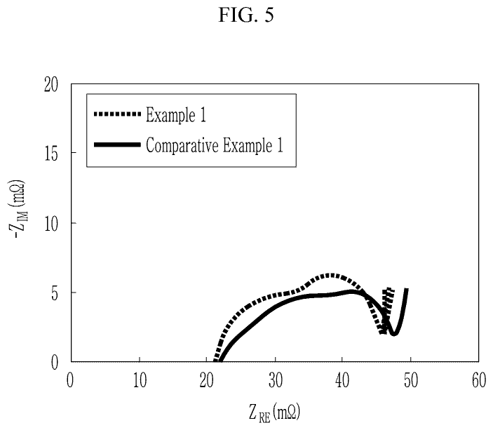

FIG. 5 is a Nyquist diagram illustrating the impedance of the rechargeable lithium battery cells of Example 1 and Comparative Example 1, and the data are shown in Table 4 below.

TABLE 4

| | 1 KHz | RT-EIS | | |
|---|---|---|---|---|
| | AC-IR | Bulk_R | Interface_R | Total_R |
| Example 1 | 22.5 | 21.0 | 24.9 | 45.9 |
| Comparative Example 1 | 26.8 | 20.3 | 27.3 | 47.6 |

Referring to Table 4, bulk resistance (Bulk-R) is a value representing movement of lithium ions in an electrolyte solution, which was no large difference in Example 1 and Comparative Example 1, but Example 1, compared with Comparative Example 1, exhibited all low AC-IR, interface resistance between mixture layer and the electrolyte solution (Interface-R), and total resistance (Total-R).

In other words, Example 1, compared with Comparative Example 1, exhibited low cell resistance through low AC-IR, which confirmed that cycle-life characteristics were improved, and in addition, increased ion mobility through low interface resistance and total resistance, which confirmed that a cycle-life maintenance rate and cycle-life characteristics at high rates were improved.

While this disclosure has been described in connection with what is presently considered to be practical example embodiments, it is to be understood that the disclosure is not limited to the disclosed embodiments. On the contrary, it is intended to cover various modifications and equivalent arrangements included within the spirit and scope of the appended claims.

Description of Symbols:

| | |
|---|---|
| 100: rechargeable lithium battery | 10: positive electrode |
| 11: positive electrode lead tab | 12: positive electrode terminal |
| 20: negative electrode | 21: negative electrode lead tab |
| 22: negative electrode terminal | 30: separator |
| 40: electrode assembly | 50: case |
| 60: sealing member | 70: electrode tab |
| 71: positive electrode tab | 72: negative electrode tab |

What is claimed is:

1. A positive electrode for a rechargeable lithium battery, the positive electrode comprising:
a positive electrode current collector;
a positive electrode active material layer; and
a positive electrode functional layer between the positive electrode current collector and the positive electrode active material layer;
wherein the positive electrode functional layer comprises a lithium iron phosphate-based compound, polyvinyl alcohol, and polyacrylic acid.

2. The positive electrode as claimed in claim 1, wherein:
the lithium iron phosphate-based compound is represented by Chemical Formula 1 or Chemical Formula 2: 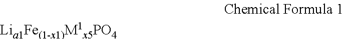
wherein, in Chemical Formula 1, 0.90≤a1≤1.5, 0≤x1≤0.4, and M¹ comprises at least one of AI, B, Ca, Ce, Cr, Cu, La, Mg, Mn, Mo, Nb, Ni, Si, Sn, Sr, Ti, V, W, Y, Zn, and Zr: 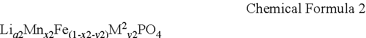
wherein, in Chemical Formula 2, 0.90≤a2≤1.5, 0.1<x2<0.9, 0≤y2≤0.9, and M² comprises at least one of AI, B, Ca, Ce, Cr, Cu, La, Mg, Mo, Nb, Ni, Si, Sn, Sr, Ti, V, W, Y, Zn, and Zr.

3. The positive electrode as claimed in claim 1, wherein a content of the lithium iron phosphate-based compound is greater than or equal to about 94 wt % based on 100 wt % of the positive electrode functional layer.

4. The positive electrode as claimed in claim 1, wherein a ratio (A/B) of a content of polyvinyl alcohol (A) to a content of polyacrylic acid (B) in the positive electrode functional layer is in a range of about 0.5 to about 1.3.

5. The positive electrode as claimed in claim 1, wherein:
a content of a binder other than polyvinyl alcohol and polyacrylic acid in the positive electrode functional layer is less than about 1 wt % based on 100 wt % of the positive electrode functional layer, and
a content of the conductive material in the positive electrode functional layer is less than about 1 wt % based on 100 wt % of the positive electrode functional layer.

6. The positive electrode as claimed in claim 1, wherein the positive electrode functional layer has a thickness in a range of about 1 μm to about 3.5 μm.

7. The positive electrode as claimed in claim 1, wherein:
the positive electrode active material layer comprises a positive electrode active material, and
the positive electrode active material comprises a lithium transition metal composite oxide.

8. The positive electrode as claimed in claim 7, wherein a content of the positive electrode active material is in a range of about 90 wt % to about 99.8 wt % based on 100 wt % of the positive electrode active material layer.

9. The positive electrode as claimed in claim 7, wherein:
the positive electrode active material layer further comprises a binder and a conductive material, and
a content of the binder is in a range about 0.1 wt % to about 5 wt %, and a content of the conductive material is in a range about 0.1 wt % to about 5 wt % based on 100 wt % of the total positive electrode active material layer.

10. The positive electrode as claimed in claim 1, wherein the positive electrode functional layer is located between the positive electrode current collector and the positive electrode active material layer, and is also located on another surface of the positive electrode active material layer where the positive electrode functional layer is not located.

11. The positive electrode as claimed in claim 1, wherein the positive electrode functional layer has an adhesive strength that is greater than or equal to about 25 gf/mm as measured using a universal testing machine.

12. A rechargeable lithium battery comprising the positive electrode of claim 1, a negative electrode, and an electrolyte.

13. The rechargeable lithium battery as claimed in claim 12, wherein the negative electrode comprises a negative electrode current collector, and a negative electrode active material layer located on the negative electrode current collector and including a carbon-based negative electrode active material.

14. The rechargeable lithium battery as claimed in claim 13, wherein the negative electrode active material layer further comprises a binder and a conductive material.
